(19) United States
(12) Patent Application Publication
(10) Pub. No.: US 2012/0092469 A1
(43) Pub. Date: Apr. 19, 2012

(54) SWITCHABLE 3D STEREOSCOPIC AND 2D MULTIPROGRAM VIEWING SYSTEM AND METHOD

(76) Inventor: Albert Kovalick, Santa Clara, CA (US)

(21) Appl. No.: 12/905,538

(22) Filed: Oct. 15, 2010

(51) Int. Cl. H04N 13/04

(52) U.S. Cl. 348/56; 348/E13.036

(57) ABSTRACT

Systems and methods for concurrently displaying two different 2D video programs on a screen of a stereoscopic 3D-enabled video viewing system. A control unit switches active shutter glasses in synchrony with the display of frames on the display screen, such that both shutters are open when frames corresponding to a first program are displayed, and both shutters are closed when frames corresponding to a second program are displayed, so that a viewer wearing the glasses sees only the first program. For higher refresh rate displays, more than two different programs can be displayed concurrently by interleaving the display of frames from more than two programs. Multiple viewers, each with a pair of active shutter glasses, can each independently choose the program they wish to watch on the single display screen. This viewing mode may leverage the 3D broadcast content delivery chain, or alternatively use appropriately encoded video stored on DVD, hard disk, or other storage.

### BACKGROUND

Stereoscopic viewing systems have been implemented in a variety of ways over the past decades. The systems display two different images, one to be shown only to the left eye of a viewer, and one to be shown only to the right eye. When these images correspond to a stereoscopic pair, the brain fuses the two images into one three dimensional scene. One widely deployed method of directing different images to the left eye and the right eye is to use active shutter glasses that can switch between the right and left eye at a 120 Hz frame rate, or higher, such that each eye independently sees only the appropriate image for that eye at a 60 Hz rate, or higher. The synchronized right/left switching aligns with the screen switched image to produce a stereoscopic viewing effect.

In many systems, the stereoscopic glasses are synchronized with the screen image using an IR or RF signal such that the timing of the screen image (say an image intended for the right eye) causes the right shutter to open by becoming transparent, and the left shutter to close by becoming opaque. One frame later, the state of the shutters is reversed. This operation creates the sensation of viewing a stereoscopic 3D image.

### SUMMARY

The stereoscopic 3D video delivery chain is leveraged to display two or more two dimensional video programs instead of a single stereoscopic program. The system uses a modified pair of active shutter glasses, in which both left and right shutters are switched into a transparent mode only when frames of a selected 2D program are displayed on a screen. The system permits a viewer to choose one of a plurality of 2D programs, and also enables more than one viewer to share the same screen while each watches a different program.

In general, in one aspect, a method of concurrently providing a plurality of video programs for viewing on a screen comprises: providing a pair of shutter glasses for use by a viewer, the pair of shutter glasses having a left shutter and a right shutter; providing a control unit for controlling a state of optical transparency of the left shutter and the right shutter; for each of the plurality of video programs, displaying on the screen a sequence of frames corresponding to that video program; in response to a selection by the viewer of a first selected one of the plurality of video programs, causing the control unit to place the left shutter and the right shutter in a transparent state when frames corresponding to the first selected one of the plurality of video programs are displayed, and causing the control unit to place the left shutter and the right shutter in an opaque state when frames corresponding to any of the plurality of video programs other than the first selected one of the plurality of video programs are displayed.

Various embodiments include one or more of the following features. The control unit controls the state of optical transparency of the optical shutters by transmitting an infrared signal or a RF signal to the pair of shutter glasses. The pair of shutter glasses includes a program control switch that enables the viewer to select one of the video programs for viewing. A first program of the plurality of video programs shows a first view of a scene and a second program of the plurality of programs displays a second view of the scene. The second view is a close-up view of the scene. A second program corresponds to the first program with added subtitles, which may be in the same language as the spoken dialog or in a different language. The pair of glasses includes a viewer-operable input control, wherein selecting a first state of the input control places the glasses in a stereoscopic viewing mode wherein the left shutter and the right shutter are placed in opposite states of transparency, and wherein selecting one or more additional states of the input control enables the viewer to select the first selected one of the plurality of programs for viewing in 2D. A remote control unit enables the viewer to select one of a stereoscopic mode in which the left shutter and the right shutter are placed in opposite states of transparency, and a 2D mode, wherein the left shutter and the right shutter are placed in the same state of transparency, and wherein the pair of glasses includes an input control that is operative when the 2D mode is selected, and wherein the viewer selects the first one of the plurality of programs for viewing using the viewer-operable input control. Providing a second pair of shutter glasses for use by a second viewer, the second pair of shutter glasses having a left shutter and a right shutter, wherein a state of optical transparency of the shutters of the second pair of glasses is controllable by the control unit; and in response to a selection by the second viewer of a second selected one of the plurality of video programs, causing the control unit to place both shutters of the second pair of glasses in a transparent state when frames corresponding to the selected second one of the plurality of video programs are displayed, and causing the control unit to place both shutters of the second pair of glasses in an opaque state when frames corresponding to any of the plurality of video programs other than the selected second one of the plurality of video programs are displayed. The second selected one of the plurality of programs may be the same as or different from the first selected one of the plurality of programs.

In general, under another aspect, a video viewing system for viewing one of a plurality of video programs that are displayed concurrently on a video display screen comprises: a pair of shutter glasses for use by a viewer, the pair of shutter glasses having a left shutter and a right shutter; a control unit for controlling a state of transparency of the left shutter and the right shutter, the control unit having a stereoscopic mode and a 2D mode; and wherein the control unit, when in 2D mode, places the left shutter and the right shutter in a transparent state when frames corresponding to a selected one of the plurality of video programs are displayed on the video display screen, and wherein the control unit places the left shutter and the right shutter in an opaque state when frames corresponding to any of the plurality of video programs other than the selected one of the plurality of video programs are displayed.

Various embodiments include one or more of the following features. The pair of shutter glasses includes a program control switch enabling the viewer to select one of the plurality of video programs. A first program of the plurality of video programs shows a first view of a scene and a second program of the plurality of programs displays a second view of the same scene. The system further includes a remote control unit enabling the viewer to place the control unit in a selected one of the stereoscopic mode and the 2D mode. The system further includes a second pair of shutter glasses for use by a second viewer, the second pair of shutter glasses having a left shutter and a right shutter, wherein a state of optical transparency of the left shutter and the right shutter of the second pair of glasses is controllable by the control unit; and in response to a selection by the second viewer of a second selected one of the plurality of video programs, causing the control unit to place both shutters of the second pair of glasses in a transparent state when frames corresponding to the second selected one of the plurality of video programs are displayed, and causing the control unit to place both shutters of the second pair of glasses in an opaque state when frames corresponding to any of the plurality of video programs other than the selected second one of the plurality of video programs are displayed.

In general, in yet another aspect, a video display method comprises: during a first time interval, displaying a frame of a first video program on a video display screen, enabling a first viewer to view the frame of the first video program; and during a second time interval, displaying a frame of a second video program on the screen, and preventing the first viewer from viewing the second image, wherein the first time interval and the second time interval each have a duration equal to a refresh time of the video display screen, and the second time interval immediately succeeds the first time interval.

Various embodiments include the following feature. During the first time interval, preventing a second viewer from viewing the frame of the first video program and during the second time interval, enabling the second viewer to view the frame of the second video program.

In general, in a still further aspect, a video display method comprises: during a first time interval, displaying a frame of a first video program on a video display screen, enabling a first viewer to view the frame of the first video program, and preventing a second viewer from viewing the frame of the first video program, wherein the first time interval has a duration equal to a refresh time of the video display screen.

Various embodiments include the following feature. During a second time interval immediately succeeding the first time interval, displaying a frame of a second video program on the video display screen, preventing the first viewer from viewing the frame of the second video program, and enabling the second viewer to view the frame of the second video program, wherein the second time interval has a duration equal to the refresh time of the video display screen.

In general, in yet another aspect, a video viewing system includes: a video display screen; a pair of active shutter glasses for a viewer of the video display screen; and a control unit for controlling the video display screen and the pair of active shutter glasses; wherein during a first time interval the control unit causes the video display screen to display a frame of a first video program and place a left shutter and a right shutter of the active shutter glasses in a transparent state; and wherein during a second time interval the control unit causes the video display screen to display a frame of a second video program and place the left shutter and the right shutter of the active shutter glasses in an opaque state; and wherein the first time interval and the second time interval each have a duration equal to a refresh time of the video display screen, and the second time interval immediately succeeds the first time interval.

In general, in a further aspect, a video viewing system includes a video display screen, a first pair of active shutter glasses, a second pair of active shutter glasses, and a control unit for controlling the display screen and the active shutter glasses, wherein during a first time interval the control unit (i) causes the video display screen to display a frame of a first video program, (ii) places the first pair of active shutter glasses in a transparent state, and (iii) places the second pair of active shutter glasses in an opaque state, wherein the first time interval has a duration equal to a refresh time of the video display screen.

Various embodiments include the following feature. During a second time interval immediately succeeding the first time interval, the control unit (i) causes the video display screen to display a frame of a second video program on the video display screen, (ii) places the first pair of active shutter glasses in an opaque state, and (iii) places the second pair of active shutter glasses in a transparent state, wherein the second time interval has a duration equal to the refresh time of the video display screen.

### BRIEF DESCRIPTION OF THE DRAWINGS

FIG. 1 is a diagram illustrating the components of a conventional stereoscopic 3D viewing system. The image is projected such that the viewers wearing active shutter glasses can see the same 3D stereoscopic image.

FIG. 2 is a diagram illustrating a viewing system enabling viewers to independently select one viewpoint among a plurality of viewpoints of a scene.

FIG. 3 is a diagram illustrating a viewing system enabling a viewer to watch a picture with subtitles while other viewers, watching the same screen, view the picture with added subtitles.

### DETAILED DESCRIPTION

A modified shutter timing system enables wearers of active glasses to view a selectable choice of two or more 2D images rather than one stereoscopic 3D image. We refer to the situation when two 2D video choices are available as 2×2D.

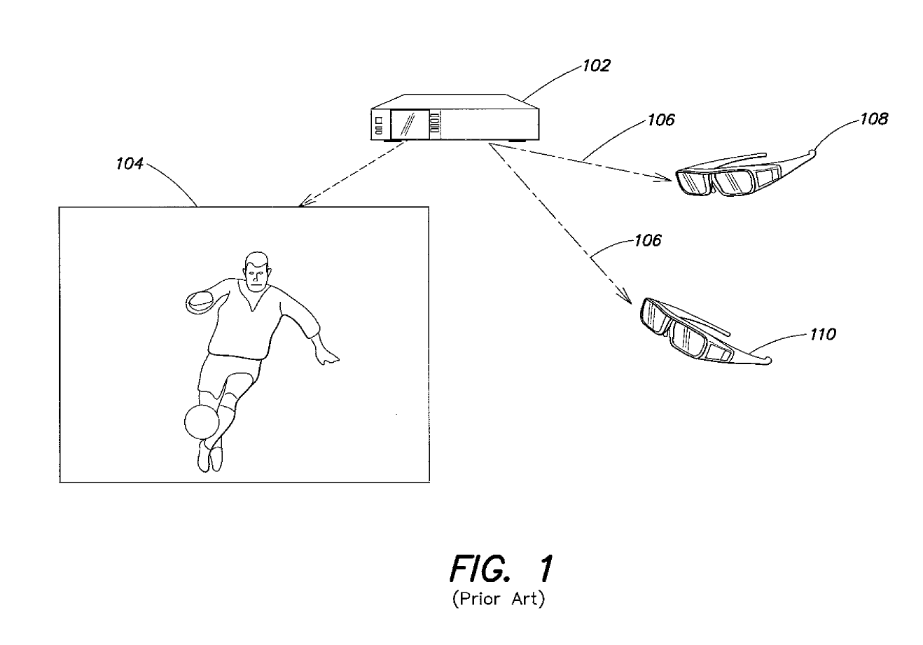

In normal stereoscopic 3D viewing, typically for residential use, the active shutter glasses alternate between opening the left eye and the right eye at a 120 Hz frame rate (or higher) such that each eye independently sees only the appropriate image for that eye at a 60 Hz rate (or higher). Each frame is displayed on the screen for 1/120 second corresponding to the refresh time of a 120 Hz monitor, but the shutters cause each eye to see only every other displayed frame. The synchronized left/right switching aligns with the screen to produce a stereoscopic viewing environment. FIG. 1 illustrates the typical 3D viewing experience. 3D enabled TV receiver 102 receives stereoscopic program signals and sends images for both the left eye and right eye to “3D” enabled TV screen 104. Receiver 102 also sends IR or RF signals 106 to that are received by one or more active shutter glasses 108, 110 to control the state of optical transparence of the left and right shutters in synchrony with the images displayed on TV 104. When the image intended for the left eye is displayed, a signal is sent to cause the left shutter to become transparent (i.e., to open) and the right shutter to become opaque (i.e., to close), thus enabling only the left eye to see the image. One refresh time later, i.e., when the next frame is displayed, the control unit transmits signals to cause the reverse situation, so that the image intended for the right eye is seen only by the right eye. This operation creates the viewing sensation of a stereoscopic 3D image. The shutters in active glasses typically consist of a small panel of liquid crystal.

In 2×2D viewing, the active glasses open and close the shutters for both eyes at the same time. When both shutters are open, the viewer sees a 2D frame that is intended for the viewer to see. When both shutters are closed, the viewer misses a 2D frame that is not intended for the viewer to see. The active glasses can be switched from stereoscopic 3D viewing mode to 2D viewing mode, and further to select which 2D program to view within the 2D viewing mode. In this manner, two 2D programs can be shown on a single display, albeit with each program having half the full frame rate of the display. This can be extended to more than two programs; for N programs, each program is shown at the full frame rate divided by N.

The frames for each of the two or more 2D video programs are displayed sequentially on the screen This means that one frame from each of the two or more 2D video programs is displayed before the subsequent frame from each of the other programs is displayed. Thus, for example, when displaying two programs, P1 and P2, the i^{th} and (i+1)^{th} frames are displayed in the order

### P1₁, P2ᵢ, P1ᵢ₊₁, P2ᵢ₊₁, . . .

Also, related to display times, P1ᵢ is displayed at frame time Tₓ, P2ᵢ is displayed at frame time Tₓ₊₁, P1ᵢ₊₁ is displayed, at frame time Tₓ₊₂, P2ᵢ₊₁ is displayed at frame time Tₓ₊₃, where Tₓ denotes the x^{th} frame time in the displayed sequence.

By extension, when displaying N programs P1, P2 . . . PN in 2D, the frames are displayed in the order:

### P1ᵢ, P2ᵢ. . . PNᵢ, P1ᵢ₊₁, P2ᵢ₊₁. . . PNᵢ₊₁

In the described embodiment, the viewer uses the remote control to select the 2×2D display mode, and then uses the modified active shutter glasses to view the screen, using an associated switch on the glasses to select program P1 or P2, and so on, for viewing. In some embodiments, the glasses include multiple controls, such as a first control to select between stereoscopic 3D mode and multi-program mono mode, and a second control for use within the multi-program mono mode to select one of the more than one mono programs for viewing.

Multiple 2D programs for viewing using stereoscopic 3D viewing systems may be distributed via cable networks, satellite, via digital networks, such as the Internet, DVD or similar optical storage, or via over the air broadcasts. In each of these cases, a receiver unit, which can be implemented in a TV, set-top box, personal computer or similar device, receives and demultiplexes the various programs in the received signals, and sends the media to the appropriate output devices, i.e., the video to the display screen, and the audio to a sound output system, either integral to a 3D television, personal computer, mobile viewing device, or to a separate home theater audio system, and to optional headphones for each viewer. The receiver also sends the wireless shutter control signals to the one or more active shutter glasses in its vicinity.

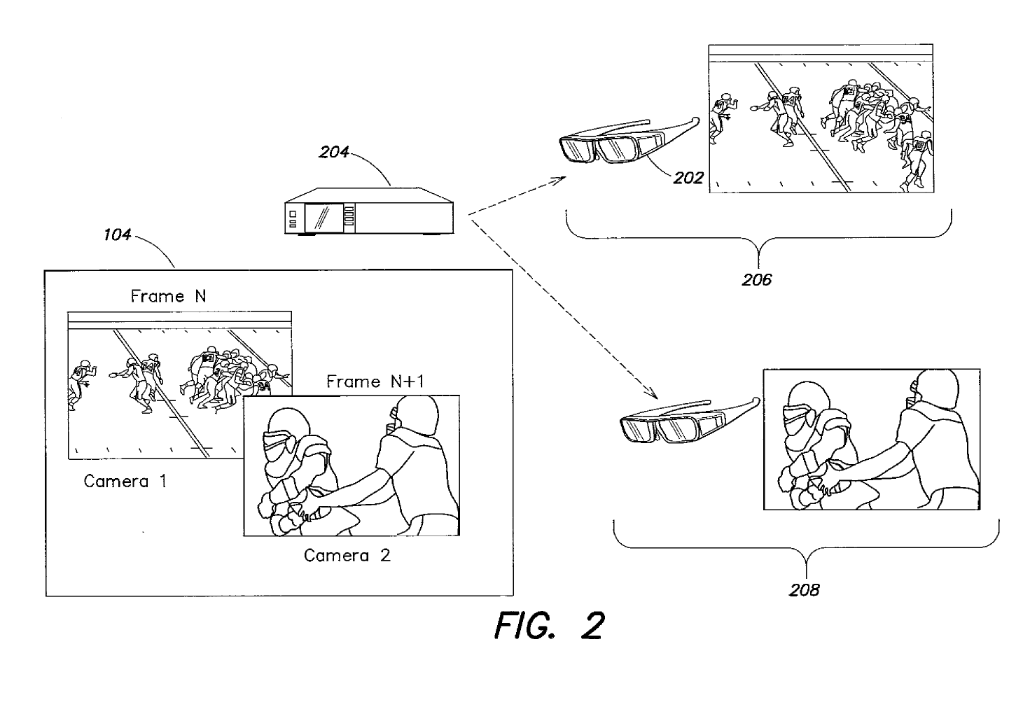

We now describe exemplary use scenarios of 2×2D viewing. The first case permits a wearer of the glasses to see either of two screen images in normal 2D. One application is viewing a two camera shot, each captured in mono 2D, of a sporting event. The viewer can control which view of two is desired. Similar to a “picture-in-picture” mode, this approach may be termed “picture-plus-picture.” Both images are broadcast simultaneously to all the receivers. For example, as illustrated in FIG. 2, given a football game, the two views may be (1) a wide shot of the playing field showing both teams in action, and (2) a close-up of the quarterback. The audio track is common to both images. The viewer selects the 2×2D viewing mode, either using control switch 202, or another controller, such as a remote control, or a switch on modified 3D enabled TV receiver 204. The viewer then selects the camera angle of choice, by using switch 202. Both images sequences are displayed on 3D TV 104 in an interleaved fashion, as described above. Without glasses, the two screen images appear superimposed on the screen. With active glasses, the viewer only sees the selected image. The operation of the shutter is as follows. To view the camera angle (1), the glasses are synchronized and shutters for both eyes are open during the time that this image is displayed on the screen (206). To view camera angle (2), the shutters of the glasses are timed to open only when image 2 is displayed (208). Thus, a viewer can choose which of two views to watch. Furthermore, additional viewers, each with their own glasses, has independent control of which view to watch, so that several people watching the same screen can each be watching their view of choice. Note, in FIG. 2, the images illustrated on the television screen are shown separated for clarity; in the actual display, each image fills the screen.

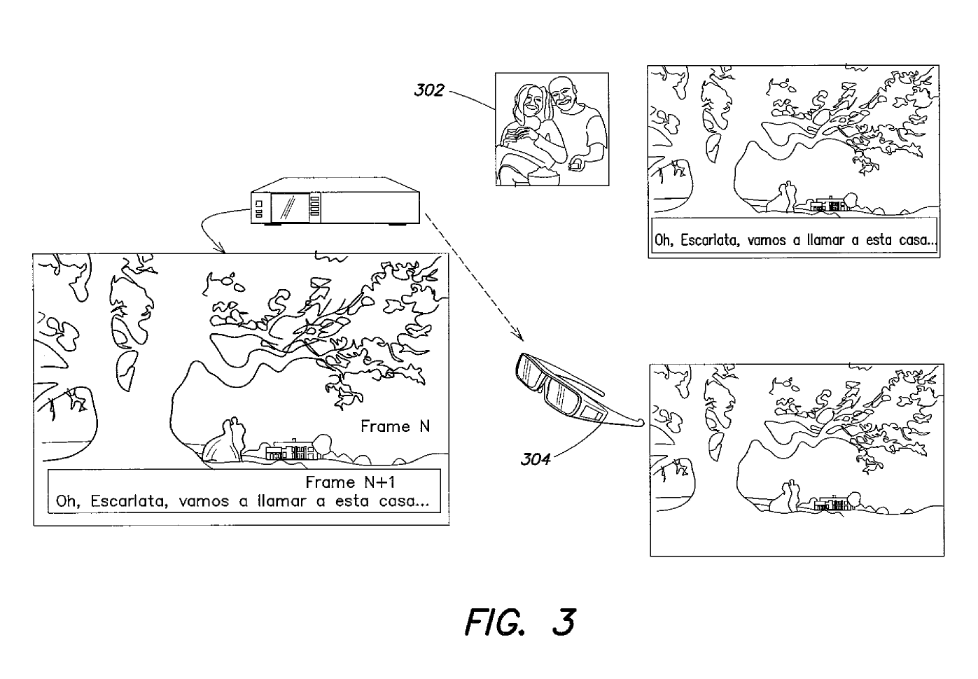

A second case enables viewing both images simultaneously or separately. This mode may be useful, for example, when one or more viewers want to see on-screen closed captions or second language text, and others do not. In this scenario, a viewer without glasses sees the main picture and the closed captions on the screen. A viewer with glasses can choose to see the main picture only, without the lower screen closed captions or second language text. This situation is illustrated in FIG. 3, in which viewer 1 (302) is not wearing glasses, and sees both programs (frame N and frame N+1) superimposed, showing both the main picture and the subtitles, and viewer 2 wearing active glasses (304), selects one of the programs (Frame N), which consists only of the main picture without the subtitles.

In a third use case, the glass wearer selects between a stereoscopic 3D image, just the left eye displayed view in which both eyes see only the left eye view, or just the right eye displayed view in which both eyes see only the right eye view. This mode is useful during the production of 3D programming when editors often need to view the 3D program or either the R/L eye view to assist them in making editorial decisions.

In a fourth use case, the system is used for viewing N independent programs simultaneously on the same display. In the 2×2D mode, as described above, two unrelated programs P1 and P2 can be displayed. Thus, viewer A can watch P1 while Viewer B can watch program P2. Each program may have a separate audio track for listening using headphones worn by the active glasses wearer. Thus, N viewers may each view and listen to a different program simultaneously. This mode leverages a single display for multiple simultaneous 2D programs, which can be especially advantageous when a consumer has invested in a large, high quality display.

The 3D broadcast content delivery chain may be used to enable the multiple 2D mono viewing modes described above. In the 3D chain, two signals corresponding to the left eye view and right eye view are compressed, multiplexed together, transmitted, decoded at the receiver, presented on a screen, and viewed using active 3D glasses. With the multiple 2D mono mode, the left and right signals may be replaced with the views from different cameras, for example, as described above. The IR/RF glasses control signal is timed to switch the glass shutters as is also described above. The normal active 3D glasses are modified to include a user-operable control, such as a switch, to enable viewers to select the viewing mode, and to choose the program.

The multiple 2D viewing modes described herein may also be implemented without the stereoscopic 3D delivery chain. For example, multiple video signals may be stored on a DVD, hard disc, or other storage media, and played back to the screen. Using the timing control methods described above, viewers wearing the 2D-enabled glasses can select which of multiple mono programs to watch.

As indicated above, the active shutter glasses that have been modified to support the multiple mono shuttering mode are also able to support the standard stereoscopic 3D mode. Thus, viewers may experience stereoscopic 3D and the multiple mono 2D mode as desired using the same display screen and a single pair of active shutter glasses.

The frame rate at which each program is displayed depends on the number of programs being offered. For example, if the screen image update frame rate is F, and N programs are displayed concurrently, then the frame rate of each of the programs is F/N, and each program is on the screen for only 1/Nth of the time. We refer to the time each frame is on the screen as the refresh time. Thus, if the screen image update frame rate is 240 Hz, and four programs are available concurrently, then each of the programs is shown at a 60 Hz frame rate, and the refresh time is 1/60 second. The shutters are timed to be open for one of four images, and to block the other three. The effect relies on precise timing and synchronization between the main screen and the viewing glasses.

For N=4, a 2×3D mode enables viewing of two 3D programs. In this mode, two 3D programs alternate on the screen as above using four successive display times as follows:

Tₓ: P1(3D, right eye); Tₓ₊₁: P2(3D, right eye); Tₓ₊₂: P1(3D, left eye); Tₓ₊₃: P2 (3D, left eye).

The display may be implemented as a liquid crystal displays (LCD), plasma display, cathode ray tube, video projection system and other video output devices capable of a refresh rate of 120 Hz or higher. Instead of liquid crystal, the glass shutters may be implemented with any material that has a controllable optical transparency, including mechanical shutter devices and semiconductor devices.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method of concurrently providing a plurality of video programs for viewing on a screen, the method comprising:
providing a pair of shutter glasses for use by a viewer, the pair of shutter glasses having a left shutter and a right shutter;
providing a control unit for controlling a state of optical transparency of the left shutter and the right shutter;
for each of the plurality of video programs, displaying on the screen a sequence of frames corresponding to that video program;
in response to a selection by the viewer of a first selected one of the plurality of video programs, causing the control unit to place the left shutter and the right shutter in a transparent state when frames corresponding to the first selected one of the plurality of video programs are displayed, and causing the control unit to place the left shutter and the right shutter in an opaque state when frames corresponding to any of the plurality of video programs other than the first selected one of the plurality of video programs are displayed.

2. The method of claim 1, wherein the control unit controls the state of optical transparency of the optical shutters by transmitting to the pair of shutter glasses at least one of an infrared signal and RF signal.

3. The method of claim 1, wherein the pair of shutter glasses includes a program control switch that enables the viewer to select the one of the video programs for viewing.

4. The method of claim 1, wherein a first program of the plurality of video programs shows a first view of a scene and a second program of the plurality of programs displays a second view of the scene.

5. The method of claim 4, wherein the second view is a close-up view of the scene.

6. The method of claim 1, wherein a second program of the plurality of programs corresponds to the first program of the plurality of programs with added subtitles.

7. The method of claim 1, wherein the pair of glasses includes a viewer-operable input control, wherein selecting a first state of the input control places the glasses in a stereoscopic viewing mode wherein the left shutter and the right shutter are placed in opposite states of transparency, and wherein selecting one or more additional states of the input control enables the viewer to select the first selected one of the plurality of programs.

8. The method of claim 1, wherein a remote control unit enables the viewer to select one of a stereoscopic mode in which the left shutter and the right shutter are placed in opposite states of transparency, and a 2D mode, wherein the left shutter and the right shutter are placed in the same state of transparency, and wherein the pair of glasses includes an input control that is operative when the 2D mode is selected, and wherein the viewer selects the first one of the plurality of programs for viewing using the viewer-operable input control.

9. The method of claim 1 further comprising:
providing a second pair of shutter glasses for use by a second viewer, the second pair of shutter glasses having a left shutter and a right shutter, wherein a state of optical transparency of the shutters of the second pair of glasses is controllable by the control unit; and
in response to a selection by the second viewer of a second selected one of the plurality of video programs, causing the control unit to place both shutters of the second pair of glasses in a transparent state when frames corresponding to the selected second one of the plurality of video programs are displayed, and causing the control unit to place both shutters of the second pair of glasses in an opaque state when frames corresponding to any of the plurality of video programs other than the selected second one of the plurality of video programs are displayed.

10. The method of claim 9, wherein the second selected one of the plurality of programs is the same as the first selected one of the plurality of programs.

11. The method of claim 9, wherein the second selected one of the plurality of programs is different from the first selected one of the plurality of programs.

12. A video viewing system for viewing one of a plurality of video programs that are displayed concurrently on a video display screen, the system comprising:
a pair of shutter glasses for use by a viewer, the pair of shutter glasses having a left shutter and a right shutter;
a control unit for controlling a state of transparency of the left shutter and the right shutter, the control unit having a stereoscopic mode and a 2D mode; and
wherein the control unit, when in 2D mode, places the left shutter and the right shutter in a transparent state when frames corresponding to a selected one of the plurality of video programs are displayed on the video display screen, and wherein the control unit places the left shutter and the right shutter in an opaque state when frames corresponding to any of the plurality of video programs other than the selected one of the plurality of video programs are displayed.

13. The video viewing system of claim 12, wherein the pair of shutter glasses includes a program control switch enabling the viewer to select the selected one of the plurality of video programs.

14. The video viewing system of claim 12, wherein a first program of the plurality of video programs shows a first view of a scene and a second program of the plurality of programs displays a second view of the scene.

15. The video viewing system of claim 12, further comprising a remote control unit enabling the viewer to place the control unit in a selected one of the stereoscopic mode and the 2D mode,

16. The video viewing system of claim 12, further comprising a second pair of shutter glasses for use by a second viewer, the second pair of shutter glasses having a left shutter and a right shutter, wherein a state of optical transparency of the left shutter and the right shutter of the second pair of glasses is controllable by the control unit; and
in response to a selection by the second viewer of a second selected one of the plurality of video programs, causing the control unit to place both shutters of the second pair of glasses in a transparent state when frames corresponding to the second selected one of the plurality of video programs are displayed, and causing the control unit to place both shutters of the second pair of glasses in an opaque state when frames corresponding to any of the plurality of video programs other than the selected second one of the plurality of video programs are displayed.

17. A method comprising:
during a first time interval:
displaying a frame of a first video program on a video display screen;
enabling a first viewer to view the frame of the first video program; and
during a second time interval:
displaying a frame of a second video program on the screen; and
preventing the first viewer from viewing the second image;
wherein the first time interval and the second time interval each have a duration equal to a refresh time of the video display screen, and the second time interval immediately succeeds the first time interval.

18. The method of claim 17, further comprising:
during the first time interval, preventing a second viewer from viewing the frame of the first video program; and
during the second time interval, enabling the second viewer to view the frame of the second video program.

19. A method comprising:
during a first time interval:
displaying a frame of a first video program on a video display screen;
enabling a first viewer to view the frame of the first video program; and
preventing a second viewer from viewing the frame of the first video program;
wherein the first time interval has a duration equal to a refresh time of the video display screen.

20. The method of claim 19, further comprising:
during a second time interval immediately succeeding the first time interval:
displaying a frame of a second video program on the video display screen;
preventing the first viewer from viewing the frame of the second video program; and
enabling the second viewer to view the frame of the second video program;
wherein the second time interval has a duration equal to the refresh time of the video display screen.

21. A video viewing system comprising:
a video display screen;
a pair of active shutter glasses for a viewer of the video display screen; and
a control unit for controlling the video display screen and the pair of active shutter glasses;
wherein during a first time interval the control unit causes the video display screen to display a frame of a first video program and place a left shutter and a right shutter of the active shutter glasses in a transparent state; and
wherein during a second time interval the control unit causes the video display screen to display a frame of a second video program and place the left shutter and the right shutter of the active shutter glasses in an opaque state; and
wherein the first time interval and the second time interval each have a duration equal to a refresh time of the video display screen, and the second time interval immediately succeeds the first time interval.

22. A video viewing system comprising:
a video display screen;
a first pair of active shutter glasses;
a second pair of active shutter glasses; and
a control unit for controlling the display screen and the active shutter glasses;
wherein during a first time interval the control unit (i) causes the video display screen to display a frame of a first video program, (ii) places the first pair of active shutter glasses in a transparent state, and (iii) places the second pair of active shutter glasses in an opaque state;
wherein the first time interval has a duration equal to a refresh time of the video display screen.

23. The video viewing system of claim 22, wherein during a second time interval immediately succeeding the first time interval, the control unit (i) causes the video display screen to display a frame of a second video program on the video display screen, (ii) places the first pair of active shutter glasses in an opaque state, and (iii) places the second pair of active shutter glasses in a transparent state, wherein the second time interval has a duration equal to the refresh time of the video display screen.
